(19) United States
(12) Patent Application Publication
(10) Pub. No.: US 2015/0325379 A1
(43) Pub. Date: Nov. 12, 2015

(54) TANTALUM CAPACITOR

(71) Applicant: SAMSUNG ELECTRO-MECHANICS CO., LTD., Suwon-Si (KR)

(72) Inventors: Min Cheol PARK, Suwon-Si (KR); Sang Soo Park, Suwon-Si (KR)

(21) Appl. No.: 14/457,087

(22) Filed: Aug. 11, 2014

(30) Foreign Application Priority Data
May 7, 2014 (KR) 10-2014-0054244

(51) Int. Cl. H01G 9/004; H01G 9/00; H01G 9/08; H01G 2/04; H01B 1/02

(52) U.S. Cl. CPC H01G 9/004; H01G 2/04; H01B 1/02; H01G 9/08; H01G 9/0029

(57) ABSTRACT

A tantalum capacitor may include: two capacitor bodies containing a tantalum powder and disposed to have tantalum wires exposed in opposite directions, two anode lead frames connected to the tantalum wires, respectively, and two cathode lead frames having the anode lead frames disposed therebetween and having the capacitor bodies mounted thereon.

### CROSS-REFERENCE TO RELATED APPLICATION

This application claims the benefit of Korean Patent Application No. 10-2014-0054244 filed on May 7, 2014, with the Korean Intellectual Property Office, the disclosure of which is incorporated herein by reference.

### BACKGROUND

The present disclosure relates to a tantalum capacitor.

Tantalum (Ta) is a metal widely used in various industrial sectors such as aerospace and defense sectors, and the like, as well as in the fields of electrical engineering, electronic device manufacturing, mechanical engineering, and chemical engineering due to having mechanical and physical properties such as a high melting point, excellent flexibility, and high corrosion-resistance, and the like.

Since tantalum may form a stable anodic oxide film, it has been widely used as a material for miniaturized capacitors. Recently, in accordance with rapid development of an information technology (IT)-related industries such as the electronics and info-communications sectors, tantalum has been increasingly used on a year-on-year basis.

Recently, in accordance with manufacturing highly functional and multifunctional microprocessors, the intensity of transistors and current consumption have increased, and power supply voltages have decreased due to reductions in power consumption. In addition, a driving frequency may be increased in a processing rate.

Due to the above-described reasons, a transient current having a high di/dt value flows in a power supply of the microprocessor, and power supply voltage variations occur depending on the transient current and equivalent series inductance (ESL) of a decoupling capacitor.

In addition, since the amplitude of a signal wave decreases in accordance with a decrease in power supply voltage, malfunctions may occur in the case that a power supply voltage variation is above a threshold voltage of the signal wave in the microprocessor.

In general, since the power supply voltage variations are decreased by lowering the ESL of the capacitor, research into decreasing ESL levels is required, even in the case of miniaturized capacitors using tantalum.

### SUMMARY

An exemplary embodiment in the present disclosure may provide a tantalum capacitor having improved equivalent series inductance (ESL).

According to an exemplary embodiment in the present disclosure, a tantalum capacitor may include: two capacitor bodies disposed to have tantalum wires exposed in opposite directions; two cathode lead frames having the capacitor bodies mounted thereon and disposed to be spaced apart from each other in a direction intersecting with the directions in which the tantalum wires are exposed; and two anode lead frames disposed between the cathode lead frames to be connected to the tantalum wires, respectively, wherein both the cathode and anode lead frames having different polarities are led out to a surface of the capacitor.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view schematically illustrating a tantalum capacitor according to an exemplary embodiment of the present disclosure;

FIG. 2 is a transparent perspective view of FIG. 1;

FIG. 3 is an exploded perspective view illustrating first and second capacitor bodies, first and second tantalum wires, first and second anode lead frames, and first and second cathode lead frames of the tantalum capacitor according to the exemplary embodiment of the present disclosure;

FIG. 4 is an exploded perspective view illustrating first and second capacitor bodies, first and second tantalum wires, first and second anode lead frames, and first and second cathode lead frames of a tantalum capacitor according to another exemplary embodiment of the present disclosure; and

FIGS. 5A through 5D are perspective views illustrating a method of manufacturing a tantalum capacitor according to an exemplary embodiment of the present disclosure.

### DETAILED DESCRIPTION

Hereinafter, exemplary embodiments of the present disclosure will be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

A tantalum capacitor according to an exemplary embodiment of the present disclosure may include: first and second capacitor bodies containing tantalum powder and having first and second tantalum wires which are exposed in opposite directions; first and second cathode lead frames disposed to be spaced apart from each other in a direction intersecting with the directions in which the first and second tantalum wires are exposed, and on which both the first and second capacitor bodies are mounted; first and second anode lead frames disposed between the first and second cathode lead frames to be connected to the first and second tantalum wires, respectively; and a molded part enclosing the first and second capacitor bodies while exposing end portions of the first and second cathode lead frames and the first and second anode lead frames.

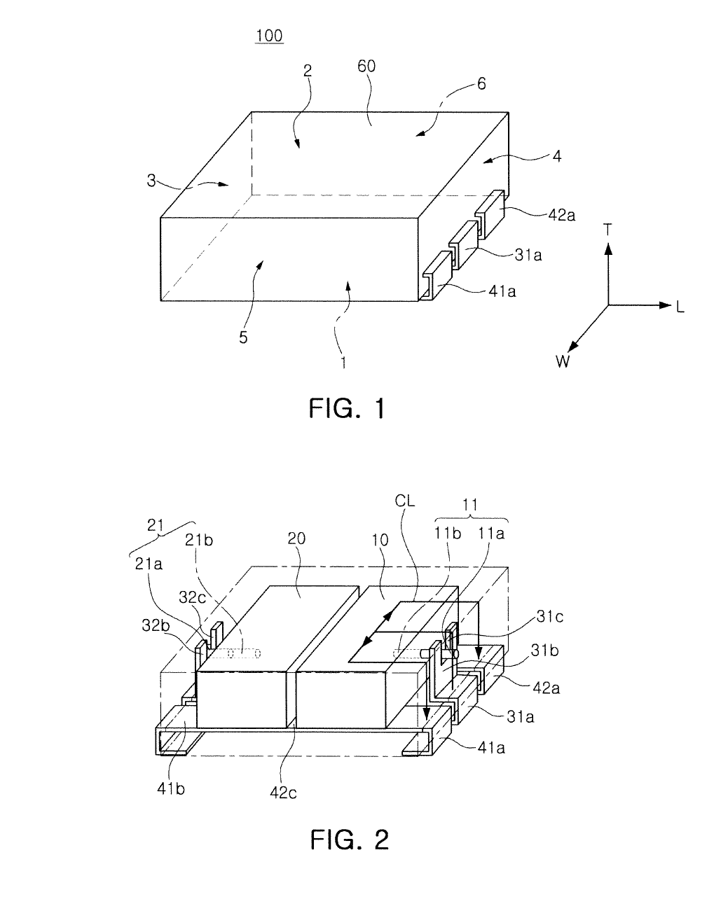

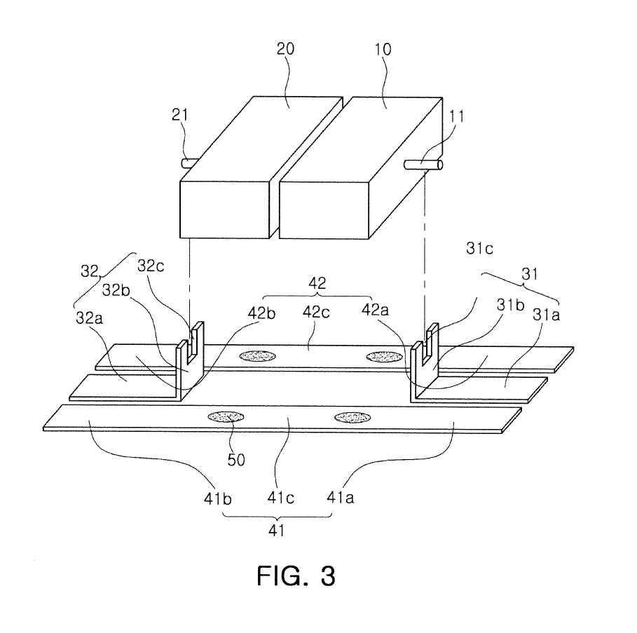

FIG. 1 is a perspective view schematically illustrating a tantalum capacitor according to an exemplary embodiment of the present disclosure, FIG. 2 is a transparent perspective view of FIG. 1, and FIG. 3 is an exploded perspective view illustrating first and second capacitor bodies, first and second tantalum wires, first and second anode lead frames, and first and second cathode lead frames of the tantalum capacitor according to the exemplary embodiment of the present disclosure.

Referring to FIGS. 1 through 3, a tantalum capacitor 100 according to an exemplary embodiment of the present disclosure may include first and second capacitor bodies 10 and 20; first and second tantalum wires 11 and 21; first and second cathode lead frames 41 and 42; first and second anode lead frames 31 and 32; and a molded part 60.

Hereinafter, in the present exemplary embodiment, for convenience of explanation, a mounting surface of the molded part 60 refers to a lower surface 1, a surface of the molded part 60 opposing the lower surface 1 in a thickness direction thereof refers to an upper surface 2, both surfaces of the molded part 60 opposing each other in a length direction thereof refer to first and second end surfaces 3 and 4, and both surfaces of the molded part 60 vertically intersecting with the first and second end surfaces 3 and 4 and opposing each other in a width direction thereof refer to third and fourth side surfaces 5 and 6.

The first and second capacitor bodies 10 and 20 may be formed of tantalum, and may function as cathodes.

In the present exemplary embodiment, the first and second tantalum wires 11 and 21 of the first and second capacitor bodies 10 and 20 may be exposed through one side surfaces of the first and second capacitor bodies 10 and 20 in a width direction thereof, respectively.

Here, the other side surfaces of the first and second capacitor bodies 10 and 20 in the width direction may face each other, and the first and second tantalum wires 11 and 21 are exposed through one side surfaces of the first and second capacitor bodies 10 and 20 in opposite directions.

In addition, the first and second capacitor bodies 10 and 20 may be formed of a porous valve acting metal body, and may be manufactured by sequentially forming a dielectric layer, a solid electrical layer, and a cathode layer on a surface of the porous valve acting metal body.

For example, the first and second capacitor bodies 10 and 20 may be manufactured by mixing the tantalum powder and a binder with each other at a predetermined ratio, agitating the mixture thereof, compressing and molding the mixture in a rectangular parallelepiped shape, and then sintering the molded body at high temperature under high vacuum.

In more detail, the tantalum capacitor has a structure using voids created when the tantalum powder is sintered and solidified. The first and second capacitor bodies 10 and 20 may be manufactured by forming tantalum oxide (Ta₂O₅) on a surface of tantalum using an anodizing method, forming a manganese dioxide (MnO₂) layer or a conductive polymer layer, which is an electrolyte, on the tantalum oxide using the tantalum oxide as a dielectric, and forming a carbon layer and a metal layer on the manganese dioxide layer or the conductive polymer layer.

In addition, carbon and silver (Ag) may be applied to surfaces of the first and capacitor bodies 10 and 20, if necessary.

The carbon may be provided to decrease a level of contact resistance on the surfaces of the first and second capacitor bodies 10 and 20, and the silver (Ag) may be provided to improve electrical connectivity at the time of mounting the first and second capacitor bodies 10 and 20 on the first and second cathode lead frames 41 and 42.

The first and second tantalum wires 11 and 21 may function as anodes.

The first and second tantalum wires 11 and 21 may include first and second insertion regions 11b and 21b positioned in the first and second capacitor bodies 10 and 20, respectively, and first and second non-insertion regions 11a and 21a exposed through one side surfaces of the first and second capacitor bodies 10 and 20 in a width direction thereof, respectively.

In addition, the first and second tantalum wires 11 and 21 may be insertedly mounted in the mixture of the tantalum powder and the binder, before compressing the mixture of the tantalum powder and the binder.

That is, the first and second capacitor bodies 10 and 20 may be manufactured by inserting the tantalum wires 11 and 21 into the tantalum powder mixed with the binder to mold a tantalum element having a desired size, and then sintering the tantalum element at about 1,000° C. to 2,000° C. under high vacuum atmosphere (10⁻⁵ torr or less) for about 30 minutes.

The first and second cathode lead frames 41 and 42 may be disposed to be spaced apart from each other in a length direction of the first and second capacitor bodies 10 and 20, and may function as ground terminals.

In addition, the first and second cathode lead frames 41 and 42 may include first and second mounting parts 41c and 42c in central portions thereof on which the first and second capacitor bodies 10 and 20 are mounted, and first cathode terminal parts 41a and 41b and second cathode terminal parts 42a and 42b led out from the first and second end surfaces 3 and 4 of the molded part 60.

Here, end portions of the first and second cathode terminal parts 41a, 41b, 42a, and 42b may be bent and extended from the first and second end surfaces 3 and 4 of the molded part 60 to portions of the lower surface 1 of the molded part 60.

In addition, a conductive adhesive layer 50 may be disposed between the mounting parts 41c and 42c of the first and second cathode lead frames 41 and 42 and the first and second capacitor bodies 10 and 20.

The conductive adhesive layer 50 may be formed, for example, by dispensing or dotting a predetermined amount of conductive adhesive containing an epoxy-based thermosetting resin and a metal powder, but is not limited thereto.

In addition, the metal powder may contain at least one of silver (Ag), gold (Au), palladium (Pd), nickel (Ni), and copper (Cu), but is not limited thereto.

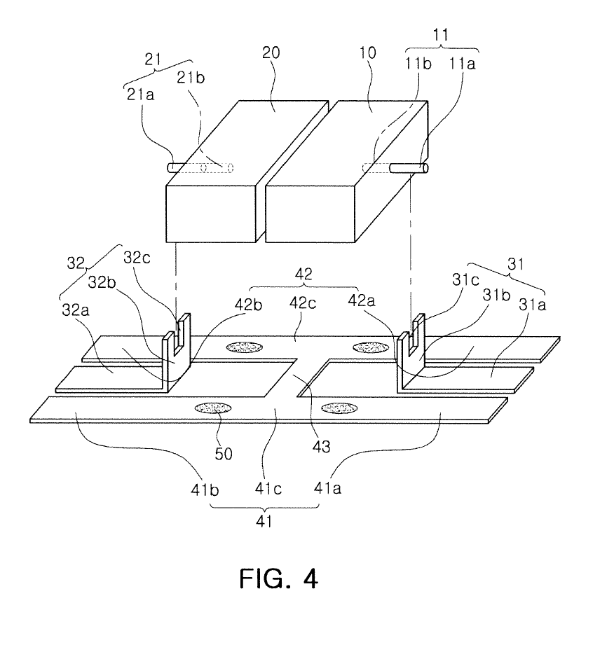

Meanwhile, referring to FIG. 4, a connection terminal 43 may connect the first and second mounting parts 41c and 42c of the first and second cathode lead frames 41 and 42 to each other inside the molded part 60.

The connection terminal 43 may electrically connect the first and second mounting parts 41c and 42c of the first and second cathode lead frames 41 and 42 to each other, thereby lowering electric resistance and inductance in the entirety of the cathode lead frames to provide a stabilized noise removal effect.

The first and second anode lead frames 31 and 32 may be disposed between the first and second cathode lead frames 41 and 42 to be spaced apart from each other in the length direction of the molded part 60.

In addition, the first and second anode lead frames 31 and 32 may include first and second anode terminal parts 31a and 32a partially exposed through the first and second end surfaces 3 and 4 of the molded part 60, respectively, and first and second wire connection parts 31b and 32b bent from end portions of the first and second anode terminal parts 31a and 32a toward the first and second non-insertion regions 11a and 21a of the first and second tantalum wires 11 and 21 inside the molded part 60 to be connected to the first and second non-insertion regions, respectively.

Here, end portions of the first and second anode terminal parts 31a and 32a may be bent and extended from the first and second end surfaces 3 and 4 of the molded part 60 to portions of the lower surface 1 of the molded part 60.

In addition, end portions of the first and second wire connection parts 31b and 32b may be provided with first and second grooves 31c and 32c into which the first and second non-insertion regions 11a and 21a of the first and second tantalum wires 11 and 21 are inserted, respectively.

Here, a conductive adhesive layer may be further formed in the first and second grooves so that the first and second non-insertion regions 11a and 21a of the first and second tantalum wires 11 and 21 are bonded to the grooves.

The conductive adhesive layer may be formed, for example, by dispensing or dotting a predetermined amount of conductive adhesive containing an epoxy-based thermosetting resin and a metal powder, but is not limited thereto.

The molded part 60 may be formed by transfer-molding an insulation resin such as an epoxy molding compound (EMC), or the like, to enclose the first and second capacitor bodies 10 and 20 and the non-insertion regions 11a and 21a of the first and second tantalum wires 11 and 21.

Here, the molded part 60 may allow the first and second cathode terminal parts 41a, 41b, 42a, and 42b of the first and second cathode lead frames 41 and 42 and the first and second anode terminal parts 31a and 32a of the first and second anode lead frames 31 and 32 to be partially exposed through the first and second end surfaces 3 and 4.

The molded part 60 may not only serve to protect the first and second tantalum wires 11 and 21 and the first and second capacitor bodies 10 and 20, but also serve to insulate the first and second capacitor bodies 10 and 20 from the first and second anode lead frames 31 and 32.

In the present exemplary embodiment, the anode and cathode lead frames may be led out through a surface of the tantalum capacitor. Since the anode lead frames are closely adjacent to each other between the cathode lead frames, a length of a current loop (CL) formed between the anode and cathode lead frames is significantly decreased, whereby equivalent series inductance (ESL), dominating high-frequency properties of the tantalum capacitor, may be reduced.

In addition, since the anode lead frames are disposed to be adjacent to the cathode lead frames, a mutual inductance may be formed between the anode and cathode lead frames, thereby further reducing the ESL by an offset effect of high-frequency current.

Further, if needed, by connecting the anode lead frames to a ground wire (GND), and connecting the anode lead frames to independent circuits, respectively, each of the first and second capacitor bodies 10 and 20 may function as an independent noise filter. Here, the tantalum capacitor may be configured to have a capacitor array and the capacitor array may be mounted on a substrate, and the like, if needed.

Hereinafter, a method of manufacturing a tantalum capacitor according to an exemplary embodiment of the present disclosure will be described.

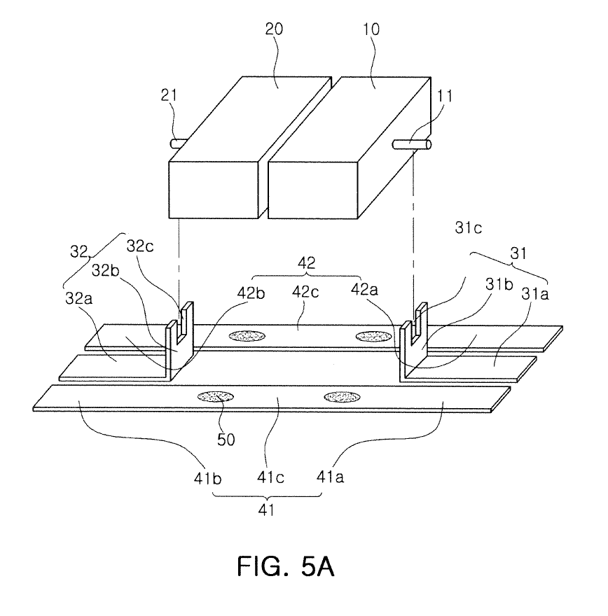

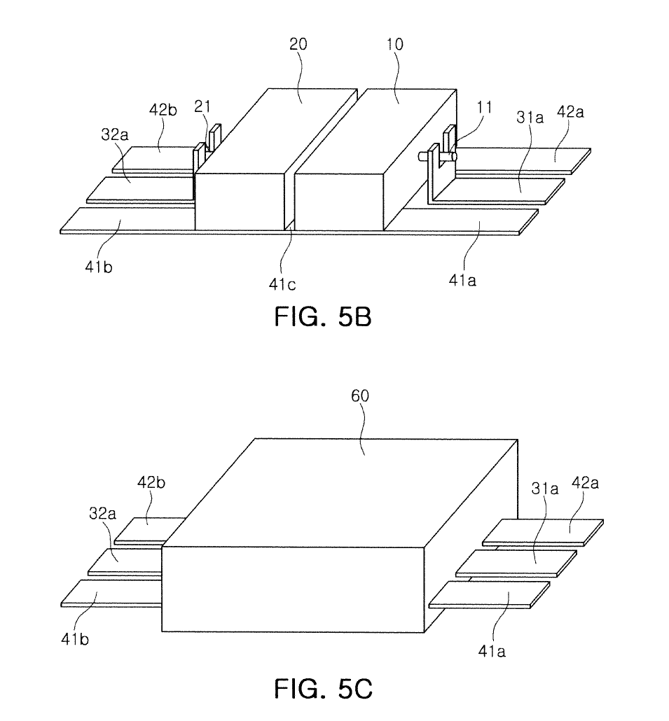

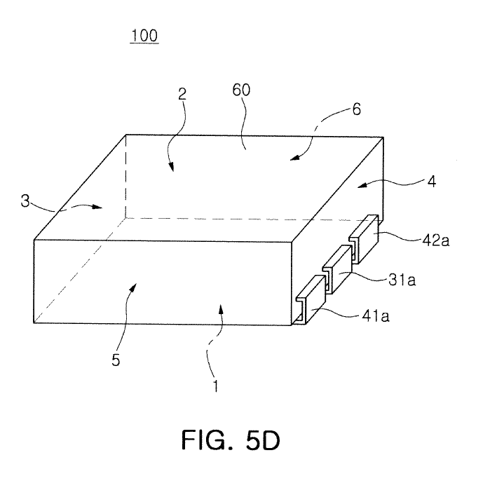

Referring to FIGS. 5A and 5B, firstly, the first and second anode lead frames 31 and 32 having the first and second wire connection parts 31b and 32b, which are bent upwardly, may be disposed to have a predetermined interval therebetween, and the first and second cathode lead frames 41 and 42 may be disposed on both sides of the first and second anode lead frames 31 and 32, with the first and second anode lead frames 31 and 32 disposed therebetween.

Then, the first and second capacitor bodies 10 and 20 formed of a tantalum powder may be prepared to have the first and second tantalum wires 11 and 21 exposed through one side surfaces of the first and second capacitor bodies in a width direction thereof.

In addition, the other side surfaces of the first and second capacitor bodies 10 and 20 may be disposed to face each other, and the first and second tantalum wires 11 and 21 are exposed through one side surfaces of the first and second capacitor bodies 10 and 20 in opposite directions.

Then, the first and second tantalum wires 11 and 21 may be connected to the first and second wire connection parts 31b and 32b of the first and second anode lead frames 31 and 32, respectively.

Here, the first and second grooves 31c and 32c may be formed in the first and second wire connection parts 31b and 32b, respectively. The first and second tantalum wires 11 and 21 may be inserted into the first and second grooves 31c and 32c, respectively, and may then be fixed using a conductive adhesive.

In addition, the first and second capacitor bodies 10 and 20 may be mounted on the first and second mounting parts 41c and 42c of the first and second cathode lead frames 41 and 42, respectively.

Here, before the first and second capacitor bodies 10 and 20 are mounted on the first and second cathode lead frames 41 and 42, the conductive adhesive layer 50 may be formed by applying a conductive adhesive to the first and second mounting parts 41c and 42c of the first and second cathode lead frames 41 and 42.

The conductive adhesive may contain an epoxy-based thermosetting resin and a conductive metal powder, and the conductive adhesive layer 50 may be formed by dispensing or dotting a predetermined amount of conductive adhesive.

Here, the conductive metal powder may contain at least one of silver (Ag), gold (Au), palladium (Pd), nickel (Ni), and copper (Cu), but is not limited thereto.

Then, referring to FIGS. 5C and 5D, the molded part 60 may be formed by transfer-molding a resin such as an epoxy molding compound (EMC), or the like, to enclose the first and second capacitor bodies 10 and 20.

Here, the molding process may be performed to allow both end portions of the first and second negative electrode lead frames 41 and 42 and ends portions of the first and second wire connection parts 31b and 32b of the first and second positive electrode lead frames 31 and 32 to be exposed through the first and second end surfaces 3 and 4 of the molded part 60.

Here, the molding process may be performed at a temperature of 170° C., and the EMC molding temperature and other conditions may be appropriately adjusted depending on a component and a shape of the EMC.

In addition, after the molding process, if needed, a curing process may be performed in a closed oven or under reflow curing conditions at a temperature of about 160° C. for 30 to 60 minutes.

Then, when the forming of the molded part 60 is completed, a deflashing process for removing a flash left in the molding process may be further performed.

In addition, as a subsequent process, an aging process may be further performed, if needed.

The aging process may decrease an electrical dispersion occurred in an assembly process.

Then, the exposed portions of the first and second cathode lead frames 41 and 42 may be bent to be extended from the first and second end surfaces 3 and 4 of the molded part 60 to a portion of the lower surface 1 of the molded part 60, to thereby form the first and second cathode terminal parts 41a, 41b, 42a, and 42b, and the exposed portions of the first and second anode lead frames 31 and 32 may be bent to be extended from the first and second end surfaces 3 and 4 of the molded part 60 to a portion of the lower surface 1 of the molded part 60, to thereby form the first and second anode terminal parts 31a and 32a.

As set forth above, according to exemplary embodiments of the present disclosure, the ESL of the tantalum capacitor may be reduced by significantly decreasing the length of the current loop formed between the anode and cathode lead frames.

While exemplary embodiments have been shown and described above, it will be apparent to those skilled in the art that modifications and variations could be made without departing from the spirit and scope of the present disclosure as defined by the appended claims.

What is claimed is:

1. A tantalum capacitor, comprising:
first and second capacitor bodies containing a tantalum powder and having first and second tantalum wires which are exposed in opposite directions;
first and second cathode lead frames spaced apart from each other in a direction intersecting with the directions in which the first and second tantalum wires are exposed, and on which both the first and second capacitor bodies are mounted;
first and second anode lead frames disposed between the first and second cathode lead frames to be connected to the first and second tantalum wires, respectively; and
a molded part enclosing the first and second capacitor bodies while exposing end portions of the first and second cathode lead frames and the first and second anode lead frames.

2. The tantalum capacitor of claim 1, wherein the first and second tantalum wires are exposed through one side surfaces of the first and second capacitor bodies in a width direction, respectively.

3. The tantalum capacitor of claim 1, wherein a conductive adhesive layer is disposed between the first and second capacitor bodies and the first and second cathode lead frames.

4. The tantalum capacitor of claim 1, further comprising a connection terminal connecting the first and second cathode lead frames to each other inside the molded part.

5. The tantalum capacitor of claim 1, wherein the end portions of the first and second cathode lead frames and the first and second anode lead frames are extended from one side surfaces of the molded part to a portion of amounting surface thereof.

6. The tantalum capacitor of claim 1, wherein the first and second anode lead frames are bent toward the first and second tantalum wires, respectively, inside the molded part, and
the end portions of the first and second anode lead frames are provided with grooves into which the first and second tantalum wires are inserted.

7. The tantalum capacitor of claim 1, wherein the first and second capacitor bodies generate the same amount of capacitance.

8. The tantalum capacitor of claim 1, wherein the first and second capacitor bodies generate different amounts of capacitance.

9. A tantalum capacitor, comprising:
first and second capacitor bodies containing a tantalum powder and disposed to allow one side surfaces thereof in a width direction to face each other;
first and second tantalum wires having insertion regions positioned in the first and second capacitor bodies and non-insertion regions exposed through the other side surfaces of the first and second capacitor bodies in the width direction, respectively;
first and second cathode lead frames disposed to be spaced apart from each other in a length direction of the first and second capacitor bodies, and on which the first and second capacitor bodies are mounted;
first and second anode lead frames disposed between the first and second cathode lead frames, and having one end portions connected to the non-insertion regions of the first and second tantalum wires, respectively; and
a molded part enclosing the first and second capacitor bodies and the non-insertion regions of the first and second tantalum wires, while exposing both end portions of the first and second cathode lead frames and the other end portions of the first and second anode lead frames in the width direction of the first and second capacitor bodies.

10. The tantalum capacitor of claim 9, wherein a conductive adhesive layer is disposed between the first and second capacitor bodies and the first and second cathode lead frames.

11. The tantalum capacitor of claim 9, further comprising a connection terminal connecting the first and second cathode lead frames to each other inside the molded part.

12. The tantalum capacitor of claim 9, wherein the end portions of the first and second cathode lead frames and the other end portions of the first and second anode lead frames are extended from end surfaces of the molded part in a length direction thereof to a portion of a mounting surface thereof.

13. The tantalum capacitor of claim 9, wherein the first and second anode lead frames include:
first and second anode terminal parts which are partially exposed through end surfaces of the molded part in a length direction thereof, respectively;
first and second wire connection parts bent from end portions of the first and second anode terminal parts toward the non-insertion regions of the first and second tantalum wires inside the molded part, respectively; and
first and second grooves formed in end portions of the first and second wire connection parts so that the non-insertion regions of the first and second tantalum wires are inserted thereinto, respectively.

14. The tantalum capacitor of claim 9, wherein the first and second capacitor bodies generate the same amount of capacitance.

15. The tantalum capacitor of claim 9, wherein the first and second capacitor bodies generate different amounts of capacitance.

16. A method of manufacturing a tantalum capacitor, the method comprising:
disposing first and second anode lead frames having first and second wire connection parts bent upwardly, at a predetermined interval therebetween, and disposing first and second cathode lead frames on both sides of the first and second anode lead frames so that the first and second anode lead frames are disposed therebetween;
disposing first and second capacitor bodies formed of a tantalum powder to face each other so that first and second tantalum wires are exposed in opposite directions;
mounting the first and second capacitor bodies on the first and second cathode lead frames in a state in which the first and second tantalum wires are connected to the first and second wire connection parts, respectively;
forming a molded part by molding the first and second capacitor bodies with an insulating material, while exposing both end portions of the first and second cathode lead frames and end portions of first and second anode terminal parts of the first and second anode lead frames in the directions in which the first and second tantalum wires are exposed; and
bending the exposed portions of the end portions of the first and second cathode lead frames and the first and second anode terminal parts to be extended from end surfaces of the molded part, opposing each other, to a portion of a mounting surface thereof.

17. The method of claim 16, further comprising forming a conductive adhesive layer by applying a conductive adhesive to the first and second cathode lead frames before the first and second capacitor bodies are mounted on the first and second cathode lead frames.

18. The method of claim 16, further comprising:
forming first and second grooves in the first and second wire connection parts, respectively;
inserting the first and second tantalum wires into the first and second grooves, respectively; and
fixing the first and second tantalum wires using a conductive adhesive.
